(19) United States
(12) Patent Application Publication
(10) Pub. No.: US 2013/0125043 A1
(43) Pub. Date: May 16, 2013

(54) USER INTERFACE PROVIDING METHOD AND APPARATUS FOR MOBILE TERMINAL

(71) Applicant: Samsung Electronics Co., Ltd., Gyeonggi-do (KR)

(72) Inventors: Hayoung JEON, Seoul (KR); Seokhyun YU, Seoul (KR); Jaemyoung LEE, Seoul (KR); Hyunmi PARK, Seoul (KR)

(73) Assignee: SAMSUNG ELECTRONICS CO., LTD., Gyeonggi-do (KR)

(21) Appl. No.: 13/672,976

(22) Filed: Nov. 9, 2012

(30) Foreign Application Priority Data
Nov. 10, 2011 (KR) 10-2011-0116754

(51) Int. Cl. G06F 3/0481; G06F 3/041

(52) U.S. Cl. CPC G06F 3/04815; G06F 3/041
USPC 715/782; 345/419; 345/173

(57) ABSTRACT

A user interface providing method and apparatus for a mobile terminal may include a three-dimensional user interface to assist with grouping items and displaying items, and the movement therebetween. The user interface providing method for a mobile terminal may include: outputting a three dimensional user interface screen (3D UI screen) having a first region for item display and a second region for item management; and managing at least one item using the second region.

### CLAIM OF PRIORITY

This application claims the benefit of priority under 35 U.S.C. §119(a) from a Korean patent application filed on Nov. 10, 2011 in the Korean Intellectual Property Office and assigned Serial No. 10-2011-0116754, the entire disclosure of which is hereby incorporated by reference in its entirety.

### BACKGROUND OF THE INVENTION

1. Field of the Invention

The present invention relates to a user interface of a mobile terminal. More particularly, the present invention relates to a user interface providing method and apparatus for a mobile terminal wherein items or objects can be displayed and managed using a virtual three dimensional space.

2. Description of the Related Art

Rapid advances in communication and semiconductor technologies have enabled tremendous growth in the use of mobile terminals. With such widespread utilization, mobile terminals have become a necessity of modern life. In addition to regular voice and text communication functions, there are advanced mobile terminals that can support various functions related to, for example, mobile television such as DMB or DVB, music playback based on MP3, photographing, data communication, Internet access, and wireless short-range communication. As mobile terminals now support an ever-increasing amount of different functions, there is a need in the art to develop a method that enables users to control the mobile terminals in a more rapid and convenient manner than known before. Particularly in recent years, as the number of mobile terminals having a touchscreen increases, a method is needed that enables better control of mobile terminals by means of touch interaction that is more convenient and provided in a more intuitive manner than known heretofore.

A conventional mobile terminal provides a user interface (UI) screen in a two-dimensional (2D) format. Such a user interface screen may provide only a flat area for item display and cannot provide an area for item management.

### SUMMARY OF THE INVENTION

The present invention has been made in part in view of the above problems, and the present invention comprises user interface providing method and apparatus for a mobile terminal wherein multiple items can be represented on a three dimensional (3D) screen, and the items are preferably managed in a convenient manner using a specific area of the 3D screen and functions related thereto for rapid execution.

In accordance with an exemplary embodiment of the present invention, there is an interface providing method for a mobile terminal, which preferably includes: outputting a three dimensional user interface screen (3D UI screen) having a first region for item display and a second region for item management; and managing at least one item using the second region.

In accordance with another exemplary embodiment of the present invention, there is an interface providing apparatus for a mobile terminal, which preferably includes: a touchscreen for outputting a three dimensional user interface screen (3D UI screen) having a first region for item display and a second region for item management; and a control unit controlling management of at least one item using the second region.

### BRIEF DESCRIPTION OF THE DRAWINGS

The features and advantages of the present invention will become more apparent to a person of ordinary skill in the art from the following detailed description in conjunction with the accompanying drawings, in which:

FIG. 1 is a block diagram of a mobile terminal according to an exemplary embodiment of the present invention;

FIG. 2 is a flowchart of an interface providing method for a mobile terminal according to another exemplary embodiment of the present invention;

FIG. 3 illustrates an exemplary 3D UI screen of the present invention;

FIGS. 4A to 4C are exemplary illustrations of moving items present in an item display region to a drop table region within a 3D UI screen according to the present invention;

FIGS. 5A to 5C are exemplary illustrations of moving items enrolled in a drop table region to an item display region within a 3D UI screen according to the present invention;

FIGS. 6A to 6C illustrate exemplary execution of a function related with multiple items using a drop table region according to the present invention;

FIG. 7 is an exemplary illustration of item management using a 3D UI screen according to the present invention; and

FIG. 8 is another exemplary illustration of item management using a 3D UI screen according to the present invention.

### DETAILED DESCRIPTION

Hereinafter, exemplary embodiments of the present invention are described in detail with reference to the accompanying drawings. The same reference symbols are used throughout the drawings to refer to the same or like parts. Detailed descriptions of well-known functions and structures incorporated herein may be omitted to avoid obscuring appreciation of the subject matter of the present invention by a person of ordinary skill in the art. The description of the various embodiments is to be construed as exemplary only and does not describe every possible instance of the invention. Therefore, it should be understood by a person or ordinary skill in the art that various changes and modifications may be made on the basis of the subject matter of the present invention that fall within the spirit of the invention and the scope of the appended claims.

In the present specification, the “mobile terminal” refers to a device having a touchscreen, such as a personal digital assistant (PDA), a mobile communication terminal, a smartphone, a tablet computer, or a tabletop computer, just to name some non-limiting examples.

In the present invention, a user interface (UI) screen is presented in a 3D format, and items can be conveniently managed using extra space created by 3D visualization. For example, the 3D UI screen may be presented in the form of a cylinder or a prism; one or more items may be displayed in a first region; and the items may be manipulated using a second region. Here, the first region may be a side (e.g. face) of a cylinder or a side of the prism and the second region may be a base thereof the respective cylinder or the prism.

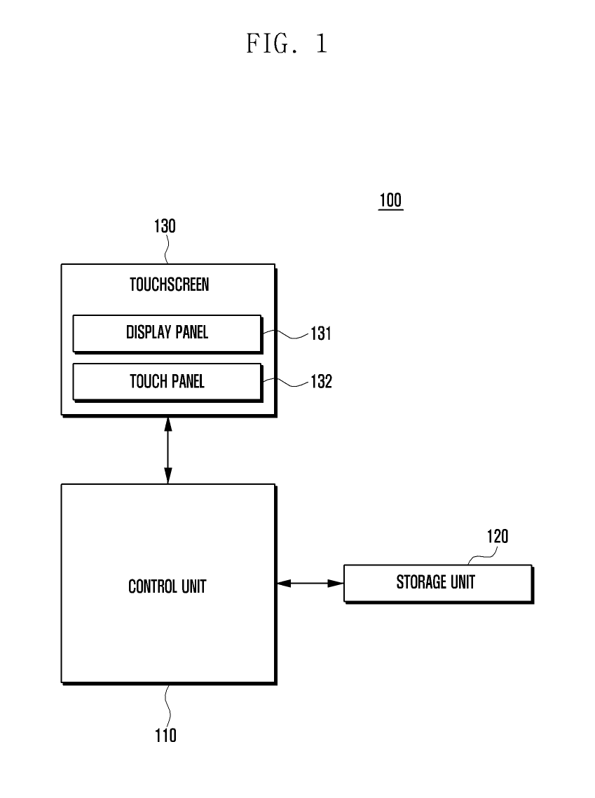

FIG. 1 is a block diagram of a mobile terminal 100 according to an exemplary embodiment of the present invention.

Referring now to FIG. 1, the mobile terminal 100 may preferably include a touchscreen 130, a storage unit 120, and a control unit 110. The touchscreen 130 may include a display panel 131 and a touch panel 132. The touchscreen 130 may comprise a liquid crystal display. However, an artisan should understand and appreciate that virtually any thin-film technology screen can be used.

With continued reference to FIG. 1, the touchscreen 130 may perform an input function and a display function. To achieve the dual functionality, the touchscreen 130 may preferably include a display panel 131 and a touch panel 132.

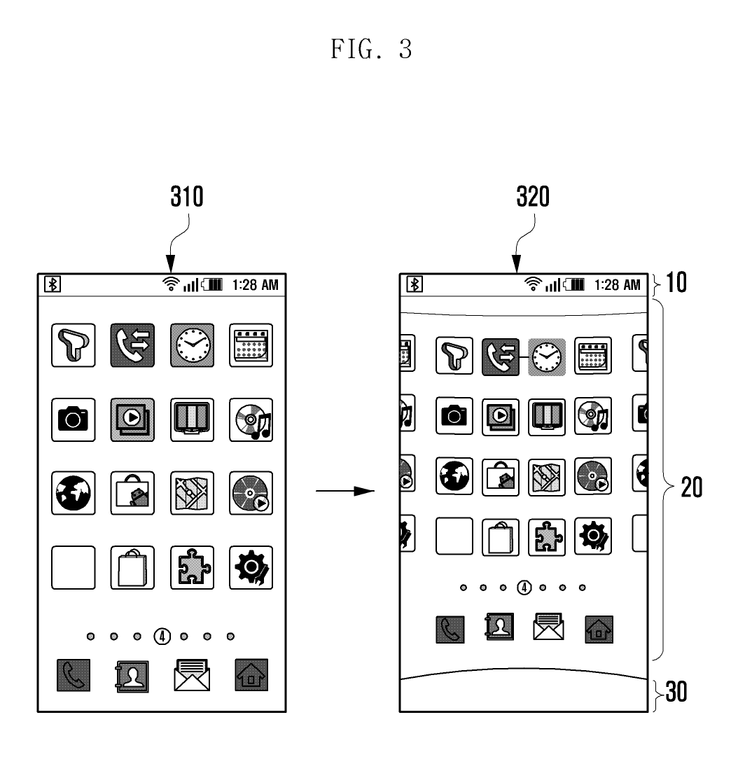

The display panel 131 displays, for example, various menus of the mobile terminal 100, information input by the user, and information to be provided to the user. For example, the display panel 131 may display various screens in the course of utilizing the mobile terminal 100, such as a home screen composed of multiple pages, a message composition screen and a call handling screen. In particular, the display panel 131 may be comprised of a 3D UI screen. Here, the 3D UI display screen may include a first region (item display region) to display one or more items and a second region (drop table region) to manage or manipulate items. The display panel 131 may provide various display screens for item management using the drop table region. The use of the drop table region is described in detail later with reference to FIGS. 3 to 8. The display panel 131 may be realized using liquid crystal display (LCD) devices, organic light emitting diodes (OLED), or active matrix organic light emitting diodes (AMOLED), just to name some non-limiting possible examples.

The touch panel 132 is placed on the display panel 131, and may generate a touch event, which indicates that contact has been sensed, in response to a touch gesture of the user with the finger (or a stylus) and send the touch event to the control unit 110. More specifically, the touch panel 132 may detect a touch event through a change in physical quantity (such as capacitance or resistance) caused by contact upon an object on the surface thereof, and sends information identifying the type of the touch event (touch, touch release, tap, double touch, touch movement such as drag, flick or multitouch) and coordinates thereof to the control unit 110. As the operation and structure of touch panels 132 are known in the art, a detailed description thereof is omitted. In particular, the touch panel 132 may generate various control signals to manipulate items on the 3D UI screen, and send the control signals to the control unit 110. Here, the control signals may preferably include, for example, a request signal to move an item from the item display region to the drop table region, a request signal to move the item from the drop table region to the item display region, and/or a request signal to perform an operation (for example, delete, move or add-to-folder) on items present in the drop table region.

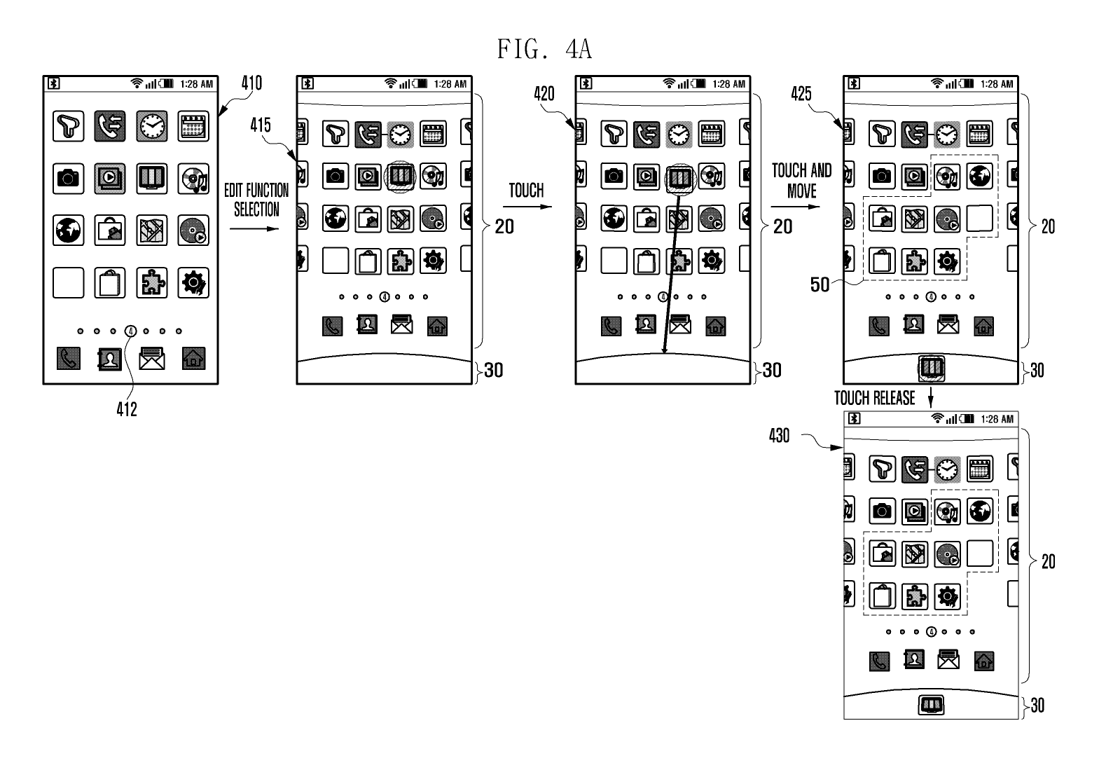

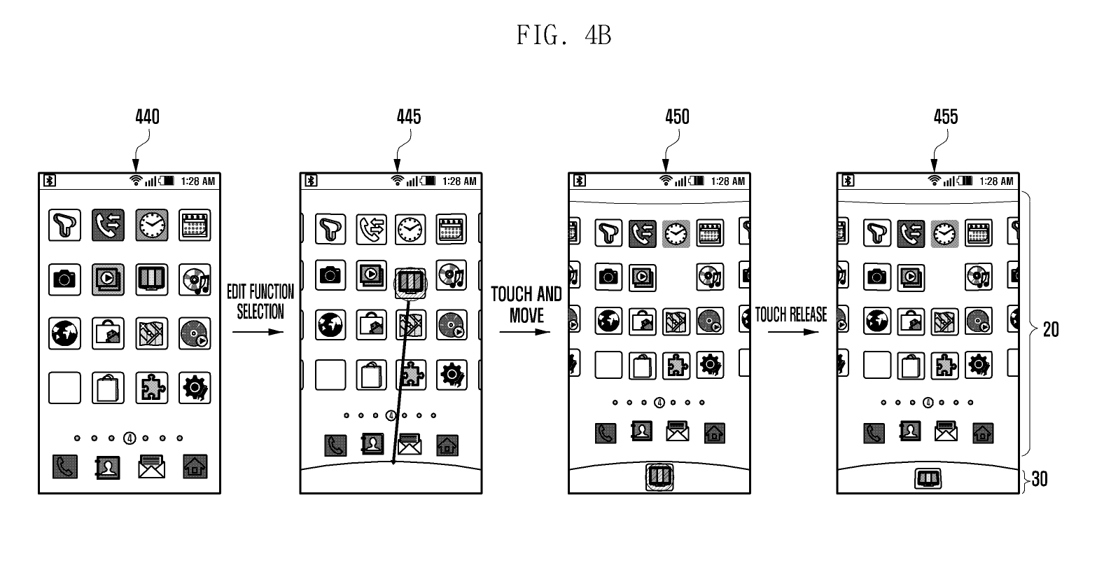

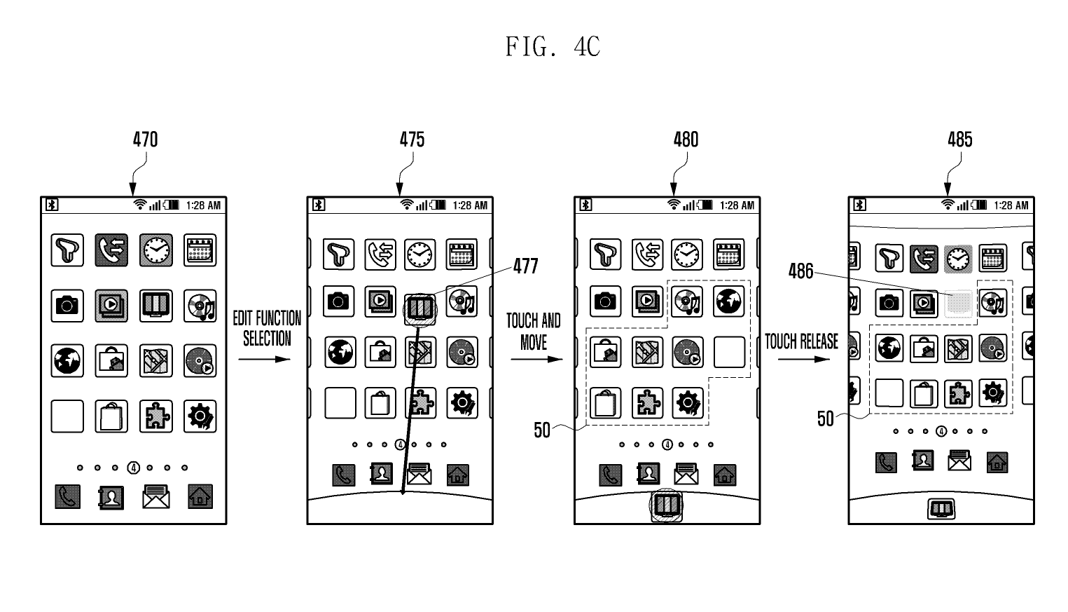

The storage unit 120, which comprises a non-transitory machine readable medium, may store programs for realizing functions of the mobile terminal 100 and user data. For example, the storage unit 120 may store an operating system (OS) that is loaded into a processor or microprocessor and executed to boot and operate the mobile terminal 100, as well as other application programs related to images, sounds and short-range wireless communication to support optional functions of the mobile terminal 100, and various content items, just to name a few possible examples. The storage unit 120 may store key maps and menu maps for proper operation of the touchscreen 130. The key maps may correspond to various keyboard layouts including but in no way limited to 3*4 and/or QWERTY layouts, and may include a control key map for controlling execution of an active application program. The menu maps may be associated with various functions, and may include a menu map for controlling execution of an active application program or programs. In particular, the storage unit 120 may store an item management program that controls a process of outputting a 3D UI screen and manipulating items through the drop table region of the 3D UI screen. The item management program may also control item manipulation operations such as move, delete and empty (described later with reference to FIGS. 4 to 8).

The storage unit 120 stores path information related to item movement. For example, the storage unit 120 may keep track of previous locations (in the item display region) of items that are moved to the drop table region. This keeping track of various locations enables moving multiple items in the drop table region back to their original locations in the item display region.

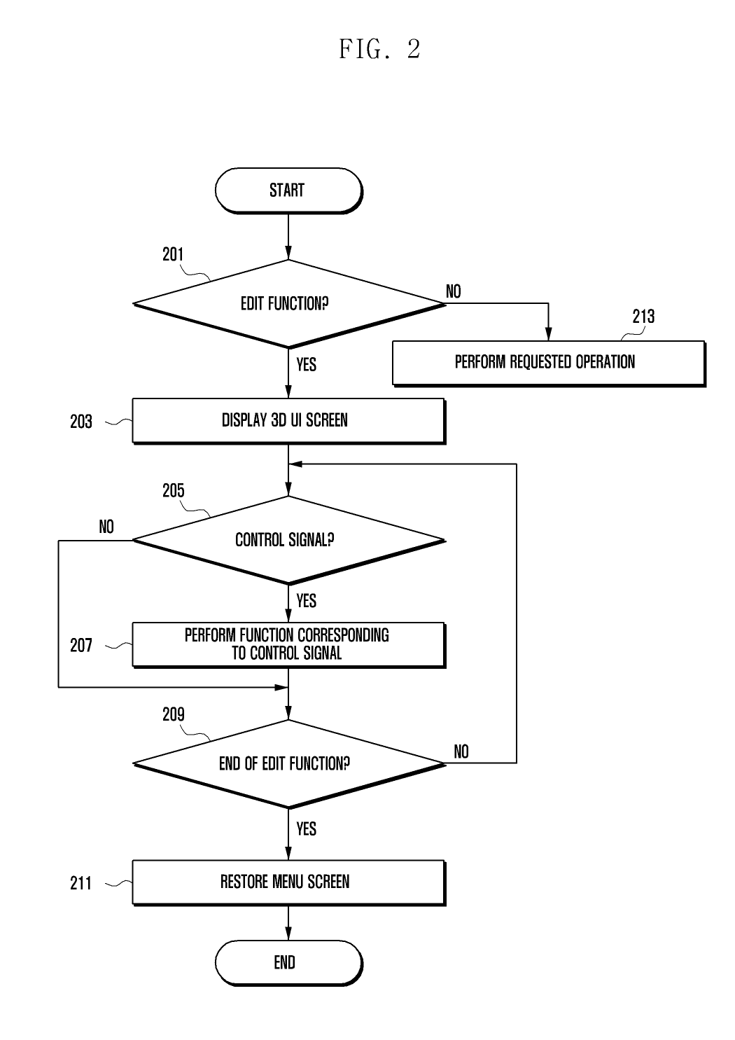

The control unit 110, which comprises hardware such as a processor or microprocessor configured for control of various functionality of the mobile terminal 100, may control the overall operation of the mobile terminal 100 and control signal exchange between internal components thereof. In particular, the control unit 110 may provide a 3D UI screen, which includes an item display region for the display of one or more items and the display of a drop table region to manage items. The control unit 110 may control a process of managing items and performing operations on items using the drop table region of the 3D UI screen. Operations of the control unit 110 are described in more detail with subsequent reference to FIGS. 2 to 8.

Although not shown in FIG. 1, the mobile terminal 100 may further include other hardware units such as a camera module for capturing still or moving images, a digital broadcast receiving module for receiving digital broadcasts, a digital music player such as an MP3 module, and a proximity sensor module for proximity sensing. With the continued trend in the digital convergence of previously separate electronic apparatuses into a single unit such as a mobile terminal, those skilled in the art should understand and appreciate that the mobile terminal 100 may further include other units comparable to the above-described units, or to provide functionality not specifically discussed hereinabove, and one unit thereof may be removed or replaced with another unit.

FIG. 2 is a flowchart illustrating exemplary operation of an interface providing method for a mobile terminal according to another exemplary embodiment of the present invention, and FIG. 3 illustrates an example of 3D UI screen of the present invention.

Referring now to FIG. 2, at (201) the control unit 110 of the mobile terminal checks whether an edit function for item management is selected from a menu screen containing a plurality of items. When at (213) the edit function is not selected, the control unit 110 may perform a requested operation. For example, the control unit 110 may perform a function (213) (for example, music playback or Internet access) associated with an item selected (or touched) by the user from the items contained in the menu screen, or may remain at step 201.

However, when at (201) the edit function is selected, then at (203) the control unit 110 controls the touchscreen 130 to display an edit screen in a 3D format, that is, a 3D UI screen. For example, referring to FIG. 3, when the edit function is selected from a 2D menu screen indicated by screen reference numeral 310, the touchscreen 130 may output a 3D UI screen as indicated by screen reference numeral 320 under control of the control unit 110.

More specifically with reference to FIG. 3, the 3D UI screen may include an indicator region 10 to display indictors for remaining battery power, current time and received signal strength, an item display region 20 to display multiple items, and a drop table region 30 to manage items, which in this particular example happens to be located at the bottom of the screen. The item display region 20 may include a page zone, which is movable in left and right directions (rotatable) and used to display multiple items, and a fixed zone in which fixed items, such as a call item, contact item, text-message item and home-screen item, are displayed.

The 3D UI screen may be displayed in the shape of a cylinder, as indicated by screen reference numeral 320. The 3D UI screen may also take many other various shapes. For example, the 3D UI screen may take the shape of a prism. In other words, the 3D UI screen may be presented in the form of a cylinder or a prism, as two non-limiting possible shapes; items are displayed in a side of the cylinder or prism; and a base of the cylinder or prism may be allocated as the drop table region 30.

With reference to FIG. 2, at (205) the control unit 110 checks whether a control signal for item management has been input. When at (205) a control signal for item management is not input, the control unit 110 performs step 209. When a control signal for item management is input, then at (207) the control unit 110 performs an operation according to the input control signal. For example, according to the input control signal, the control unit 110 control the movement of items present in the item display region 20 to the drop table region 30, or control the movement of items present in the drop table region 30 to the item display region 20. The control unit 110 may delete multiple items present in the drop table region 30 or return them to their original locations. The control unit 110 may add a folder in the item display region 20 and move multiple items present in the drop table region 30 to the new folder. The control unit 110 may change an item arrangement in the drop table region 30 by spreading stacked items into multiple rows and columns or stacking spread items into a pile. This change in arrangement will be described in more detail in connection with the description of FIGS. 4 to 8.

At (209), the control unit 110 checks whether the edit function is ended. When the edit function is not ended, the control unit 110 performs step 205. When the edit function is ended, then at (211) the control unit 110 may restore the menu screen.

In the above description, a 3D UI screen is output when an edit function is selected in a 2D menu screen. However, the present invention is not limited thereto. For example, the menu screen itself may be presented in a 3D format so that the drop table region can be used without execution of the edit function. In the above description of the operation of the process in FIG. 2, a menu screen is edited. However, the present invention is not limited to the aforementioned. For example, the home screen, which contains frequently used ones of menu items of the mobile terminal 100, may also be edited.

In the above exemplary description, the lower base of a cylinder or prism is used as the drop table region. However, the presently claimed invention is not limited thereto. For example, the upper base of a cylinder or prism may be used as the drop table region, or both the lower and upper bases thereof may also be used as the drop table region. In addition, the indicator region 10 may be not included in the 3D UI screen according to design or desire. In other words, the 3D UI screen may be composed of the item display region 20 and the drop table region 30. Any type of geometric shapes can be used, which can be contiguous or non-contiguous.

FIGS. 4A to 4C are exemplary illustrations of moving items present in the item display region to the drop table region within a 3D UI screen.

Referring now to FIG. 4A, in response to an input signal for menu screen output, the control unit 110 preferably controls the touchscreen 130 to display a menu screen as indicated by screen reference numeral 410. Here, the menu screen 410 is shown in a 2D format and may be composed of multiple pages, and many items may be arranged in multiple rows and columns in each page. Screen reference numeral 410 indicates at 412 that the menu screen is composed of seven pages and the fourth page is currently displayed based on the horizontal row of 7 items directly above the drop table region.

When an edit function is selected in a state in which the menu screen is output, the control unit 110 preferably controls the touchscreen 130 to output a 3D UI screen as indicated by screen reference numeral 415. The 3D UI screen 320 has been previously-described in connection with FIG. 3. With regard to FIG. 4, the user may touch at least one item in the item display region 20 of the 3D UI screen as indicated by screen reference numeral 420, move the touched item toward the drop table region 30 as indicated by screen reference numeral 425, and release the touched item in the drop table region 30. Next, the control unit 110 may control the touchscreen 130 to enroll the moved item in the drop table region 30 as indicated by screen reference numeral 430. Here, the control unit 110 may rearrange items present in the item display region 20 as indicated by screen reference numeral 430. In other words, the control unit 110 may fill the position of the moved item by shifting subsequent items of the moved item.

Referring now to FIG. 4B, in response to an input signal for a menu screen output, the control unit 110 may control the touchscreen 130 to output a menu screen as indicated by screen reference numeral 440. Here, the menu screen shown is the same or similar as previously-described above.

When an edit function is selected in a state in which the menu screen is already output on the display, the control unit 110 can control the touchscreen 130 to output a 3D UI screen as indicated by screen reference numeral 445. Thus the display of the screen changes from 2D to 3D upon the edit function selection. The display may sense touch (contact) by at least one item in the item display region 20 of the 3D UI screen as indicated by screen reference numeral 445, and move the touched item toward the drop table region 30 as indicated by screen reference numeral 450, and then release the touched item in the drop table region 30. The control unit 110 may then control the touchscreen 130 to enroll the moved item in the drop table region 30 as indicated by screen reference numeral 455. Here, the control unit 110 may leave the position of the moved item empty without shifting other items as indicated by screen reference numerals 450 or 455.

Referring now to FIG. 4C, in response to an input signal for a menu screen output, the control unit 110 controls the touchscreen 130 to output a menu screen as indicated by screen reference numeral 470. When an edit function is selected in a state in which the menu screen is already being output, the control unit 110 may control the touchscreen 130 to output a 3D UI screen as indicated by screen reference numeral 475. The touchscreen may detect contact with at least one item (477) on the item display region 20 of the 3D UI screen as indicated by screen reference numeral 475, and move the touched item toward the drop table region 30 as indicated by screen reference numeral 480. Here, the control unit 110 may fill the position of the moved item by shifting subsequent items 50 of the moved item as indicated by screen reference numeral 480.

When the user releases the touched item in the drop table region 30, as indicated by screen reference numeral 485, the control unit 110 may control the touchscreen 130 to enroll the moved item in the drop table region 30 and to display a distinctive ghost image 486 at the previous position of the moved item in the item display region 20. Here, the ghost image 486 may be obtained by modifying at least one of the size, transparency and color of the item having been moved to the drop table region 30. For example, as indicated by screen reference numeral 485, a translucent ghost image 486 is displayed at the previous position of the item having been moved to the drop table region 30. A ghost image 486 indicates existence of a corresponding item having been moved to the drop table region 30 and reminds the user of the original position of the item now in the drop table region. When a ghost image with a different size, transparency or color is displayed at the original position of the item having been moved to the drop table region 30, the control unit 110 may shift the subsequent items 50 of the moved item back to their original positions as indicated by screen reference numeral 485.

Hereinabove, a description is given of examples for moving items present in the item display region 20 to the drop table region 30. Next, a description is given of examples for moving items present in the drop table region 30 to the item display region 20.

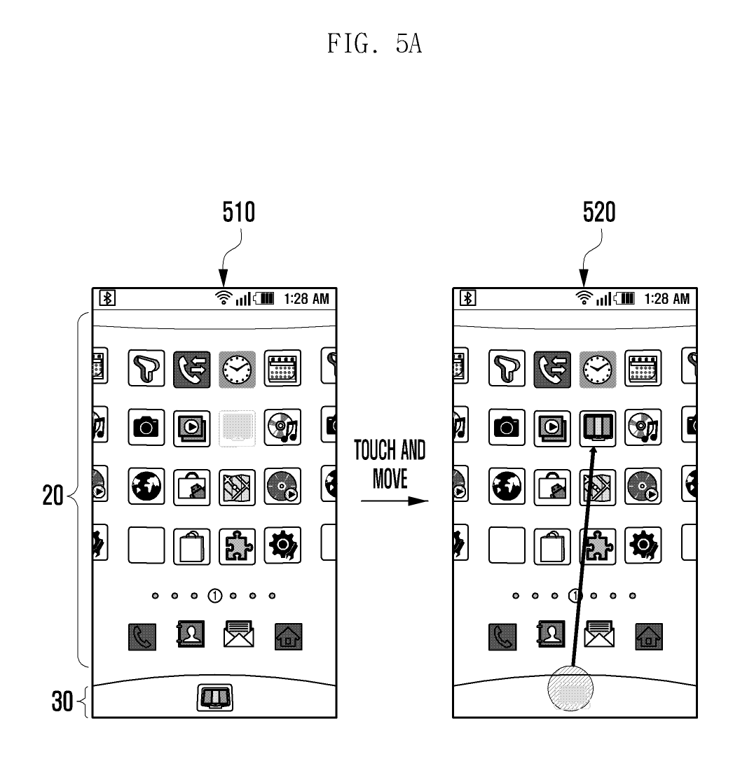

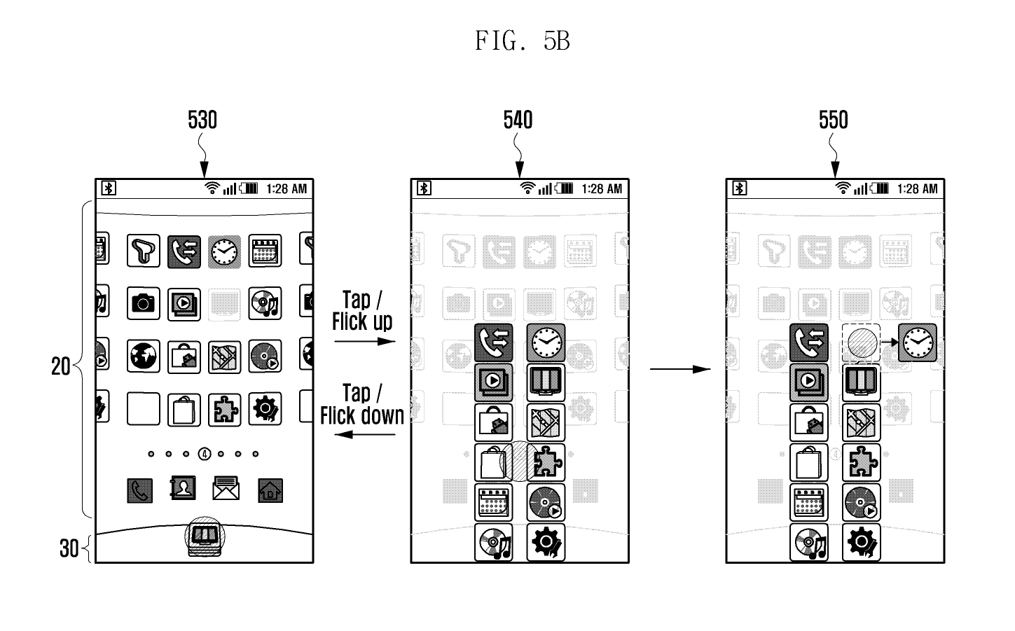

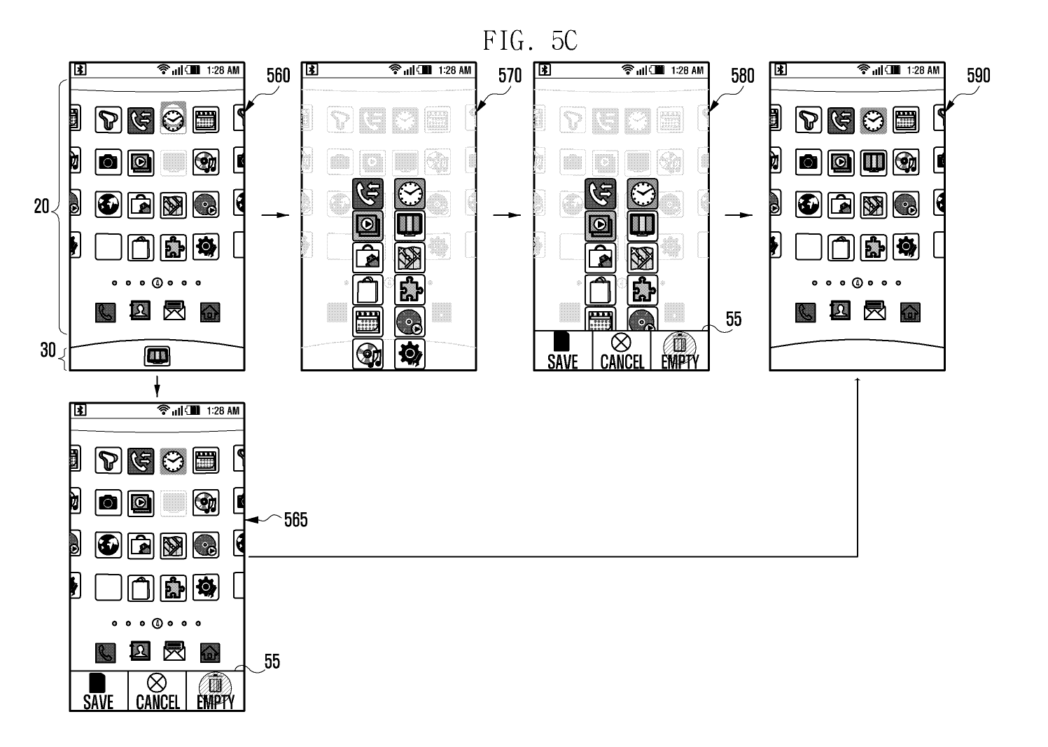

FIGS. 5A to 5C are illustrations of moving items enrolled in the drop table region to the item display region (i.e. back to item display region from the drop table region) within a 3D UI screen.

Referring to FIG. 5A, the control unit 110 (shown in FIG. 1) is configured to control the touchscreen 130 to display a 3D UI screen as indicated by screen reference numeral 510. The user may touch one item enrolled in the drop table region 30 of the 3D UI screen, move the touched item to a desired position of the item display region 20, and release the touched item as indicated by screen reference numeral 520. Then, the control unit 110 may move the touched item in the drop table region 30 to the touch release position. Here, when multiple items are stacked in the drop table region 30, the control unit 110 may control the move of the topmost one of the stacked items to the touch release position. In this way, the user may move a specific item present in the drop table region 30 to a desired position in the item display region 20 through touch, touch and movement, and touch release. Although not shown in FIG. 5A, the user may move an item present in the drop table region 30 to a page other than the current page (fourth page in the screen indicated by screen reference numeral 510) by entering a sweep interaction in the left or right direction on the item display region 20.

Referring now to FIG. 5B, the control unit 110 can be configured to control the touchscreen 130 to display a 3D UI screen as indicated by screen reference numeral 530. Here, many items are enrolled in the drop table region 30 of the 3D UI screen. When the user enters a tap on the items in the drop table region 30 of the screen reference numeral 530, the control unit 110 may arrange the items in multiple rows and columns as indicated by screen reference numeral 540. Here, as indicated by screen reference numeral 540, twelve items are enrolled in the drop table region 30.

The mobile terminal can detect: (1) a touch of a desired one of the items displayed on the touchscreen and arranged in multiple rows and columns; (2) a move (drag, flick or sweep) the touched item in a given direction in the item display region 20, and a release of the touched item. Then, the control unit 110 may control movement of the touched item to the previous position (marked by the ghost image) or to an empty position of the current page. When there is no empty position in the current page, the control unit 110 may control movement of the touched item to an empty position of the next page. When there is no empty position until the last page, the control unit 110 may add a new page and move the touched item to the new page.

When the touchscreen detects a tap on one of the items arranged in multiple rows and columns as indicated by screen reference numeral 540, the control unit 110 may control stack the spread items into a pile as indicated by screen reference numeral 530 (return to the previous item arrangement). In this case, the item arrangement is switched according to tap events. In another exemplary embodiment, the item arrangement on the touchscreen may be switched according to touch movement events. For example, multiple items stacked in a pile may be spread into multiple rows and columns according to a flick up, and multiple items spread in multiple rows and columns may be stacked in a pile according to a flick down.

Referring now to FIG. 5C, the control unit 110 may control the touchscreen 130 to display a 3D UI screen as indicated by screen reference numeral 560. Here, many items are enrolled in the drop table region 30 of the 3D UI screen. When the user enters a tap on the items in the drop table region 30, the control unit 110 may arrange the items in multiple rows and columns as indicated by screen reference numeral 570. When the user enters a separate menu key (not shown), the control unit 110 (shown in FIG. 1) may control the output of a menu window 55 containing currently available command options at a portion of the touchscreen 130 as indicated by screen reference numeral 580. Here, the menu window 55 may include options such as “save” (to store edited results), “cancel” (to discard edited results), and “empty” (to empty the drop table region 30). In a state indicated by screen reference numeral 560, when the user enters a separate menu key (not shown), the control unit 110 may output a menu window 55 containing currently available command options at a portion of the touchscreen 130 as indicated by screen reference numeral 565.

In a state indicated by screen reference numerals 565 or 580, when the user selects “empty” option, the control unit 110 may move all the items present in the drop table region 30 to the item display region 20 as indicated by screen reference numeral 590. Here, for items whose previous positions are remembered, the control unit 110 may move the items to their previous positions (for example, positions marked by ghost images). For items whose previous positions are not remembered (unknown), the control unit 110 may move the items to empty positions of the current page. When there is no empty position in the current page, the control unit 110 may move the item to an empty position of the next page. When there is no empty position until the last page, the control unit 110 may add a new page and move the item to the new page.

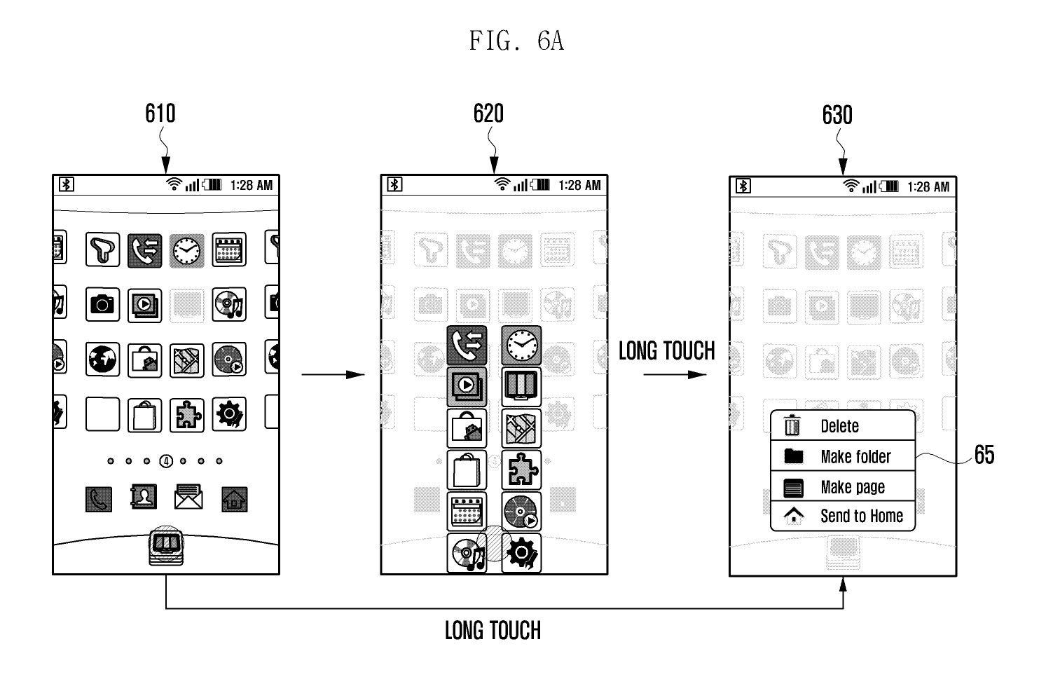

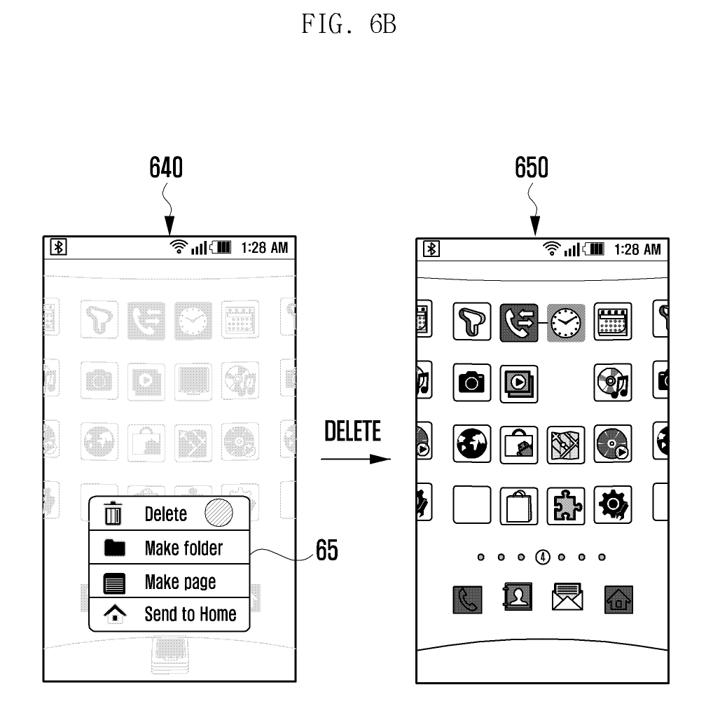

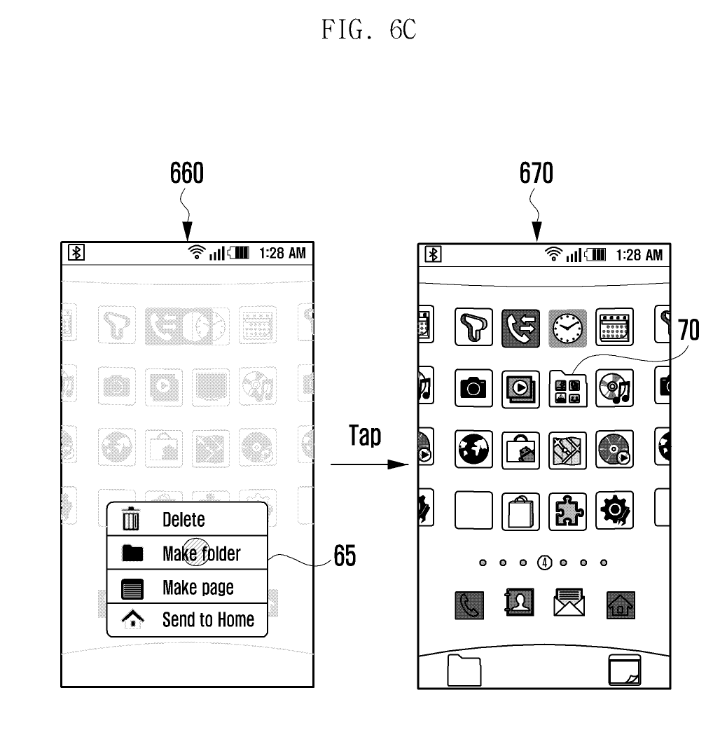

FIGS. 6A to 6C illustrate execution of a function related with multiple items using the drop table region.

Referring now to FIGS. 6A to 6C, the control unit 110 may control the touchscreen 130 (FIG. 1) to display a 3D UI screen as indicated by screen reference numeral 610. Here, many items are enrolled in the drop table region 30 of the 3D UI screen. When the touchscreen detects that the user has entered a tap on the items in the drop table region 30, the control unit 110 may arrange the items in multiple rows and columns as indicated by screen reference numeral 620. When the user enters a long touch (touch sustained for a given time or longer) at a portion of the items arranged in multiple rows and columns, the control unit 110 may control the display to output a menu popup window 65 containing command options applicable to multiple items as indicated by screen reference numeral 630. Here, the menu popup window 65 may include options, such as “delete” (to delete items in the drop table region 30), “make folder” (to create a folder at the item display region 20 and to move items in the drop table region 30 to the created folder), “make page” (to add a page in the item display region 20 and to move items in the drop table region 30 to the added page), and “send to home” (to move items in the drop table region 30 to the home screen).

As indicated by screen reference numeral 640 in FIG. 6B, the user may select “delete” option of the menu popup window 65 by entering a tap. The touchscreen detects the tap, and then, the control unit 110 may delete multiple items in the drop table region 30. Here, deletion of the multiple items may correspond, for example, to removal of applications associated with the items. After deletion, as indicated by screen reference numeral 650, no item remains in the drop table region 30 and no ghost image remains in the item display region 20.

As indicated by screen reference numeral 660 in FIG. 6C, the user may select the “make folder” option of the menu popup window 65 by entering a tap. Then, upon the touchscreen detecting the tap, the control unit 110 can be configured to create a folder 70 at the position of a ghost image and move the display of the items in the drop table region 30 to the created folder 70 as indicated by screen reference numeral 670. Here, to indicate the presence of at least one item, the folder 70 may include small images representing contained items.

With continued reference to FIG. 6C, similar to the above, when the user selects the “make page” option of the menu popup window 65 by entering a tap, the touchscreen detects the tap and the control unit 110 adds a page after the current page and move the items in the drop table region 30 to the added page. When the user selects “send to home” option of the menu popup window 65 by entering a tap, the control unit 110 may move the items in the drop table region 30 to the home screen. Here, the control unit 110 may move the items to empty positions of the home screen. For example, the topmost one of the items in the drop table region 30 (e.g. item management region) is moved to the first empty position, and the second topmost item is moved to the second empty position, and so on. When there are not enough empty positions in the home screen, the control unit 110 may add a page to the home screen.

As described above, in the present invention, an operation such as the “delete”, “make folder” or “make page” operations may be applied commonly to multiple items present in the drop table region 30, enhancing user convenience. For example, to delete or move multiple items, the user does not have to enter the same command or gesture multiple times.

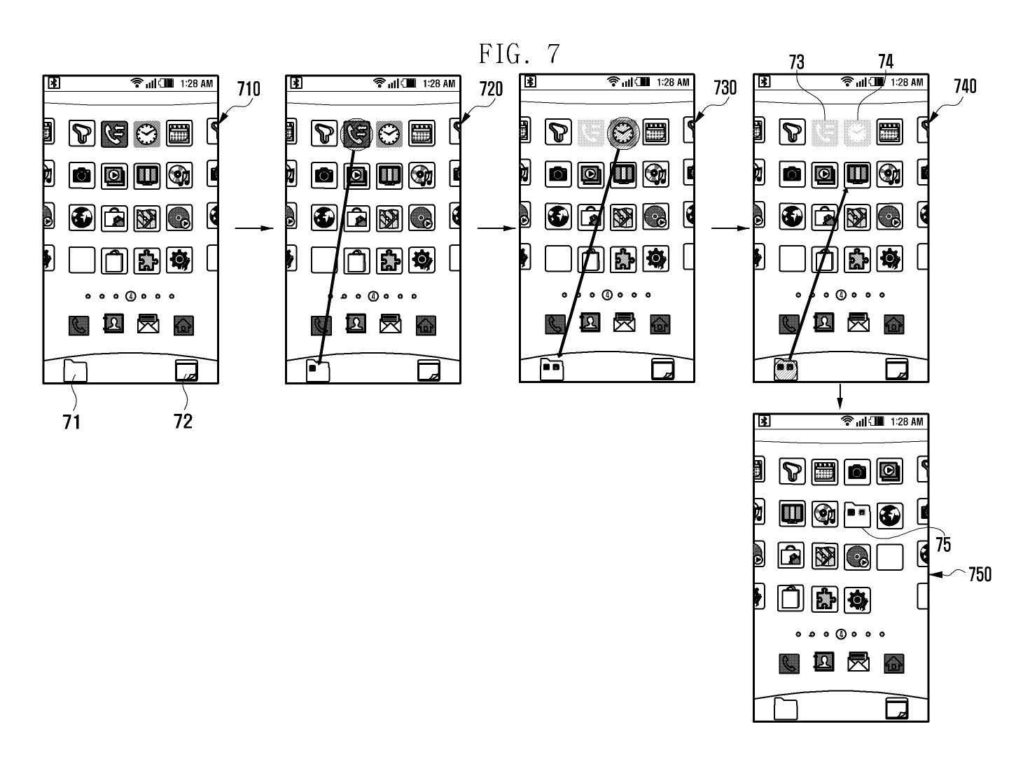

FIG. 7 is an exemplary illustration of item management using a 3D UI screen.

Referring now to FIG. 7, the control unit 110 may control the touchscreen 130 to output a 3D UI screen as indicated by screen reference numeral 710. The 3D UI screen may include an indicator region 10, an item display region 20, and a drop table region 30.

As the indicator region 10 and the item display region 20 are used similarly as in the previous exemplary embodiments, and thus a description thereof is omitted. Unlike the previous exemplary embodiments, the drop table region 30 may include a make-folder item 71 and a make-page item 72. Here, the make-folder item 71 is associated with “make folder” function described in connection with FIG. 6C, and the make-page item 72 is associated with a “make page” function.

In a state indicated by screen reference numeral 710, the user may move an item in the item display region 20 to the make-folder item 71 as indicated by screen reference numeral 720 or 730. Then, the control unit 110 may control the touchscreen 130 to display a distinctive ghost image (different from the corresponding item in terms of at least one of size, transparency and color) at the previous position of the item having moved to the make-folder item 71.

The user may touch the make-folder item 71, move the make-folder item 71 to a desired position of the item display region 20, and release the make-folder item 71 as indicated by screen reference numeral 740. Then, the control unit 110 may create a folder 75 at the touch release position and move the items in the make-folder item 71 to the created folder 75 as indicated by screen reference numeral 750. Here, the make-folder item 71 may become empty, and the ghost images 73 and 74 may be removed. As described above, the “make folder” function may be more easily performed using the make-folder item 71 in comparison to using the menu popup window 65 as in FIG. 6C.

Although not shown in FIG. 7, to move one item individually, the user may enter a tap on the make-folder item 71, and the control unit 110 is preferably configured to expand the make-folder item 71 into a popup window. Thereafter, the user may select a desired item in the popup window and move the selected item to the item display region 20.

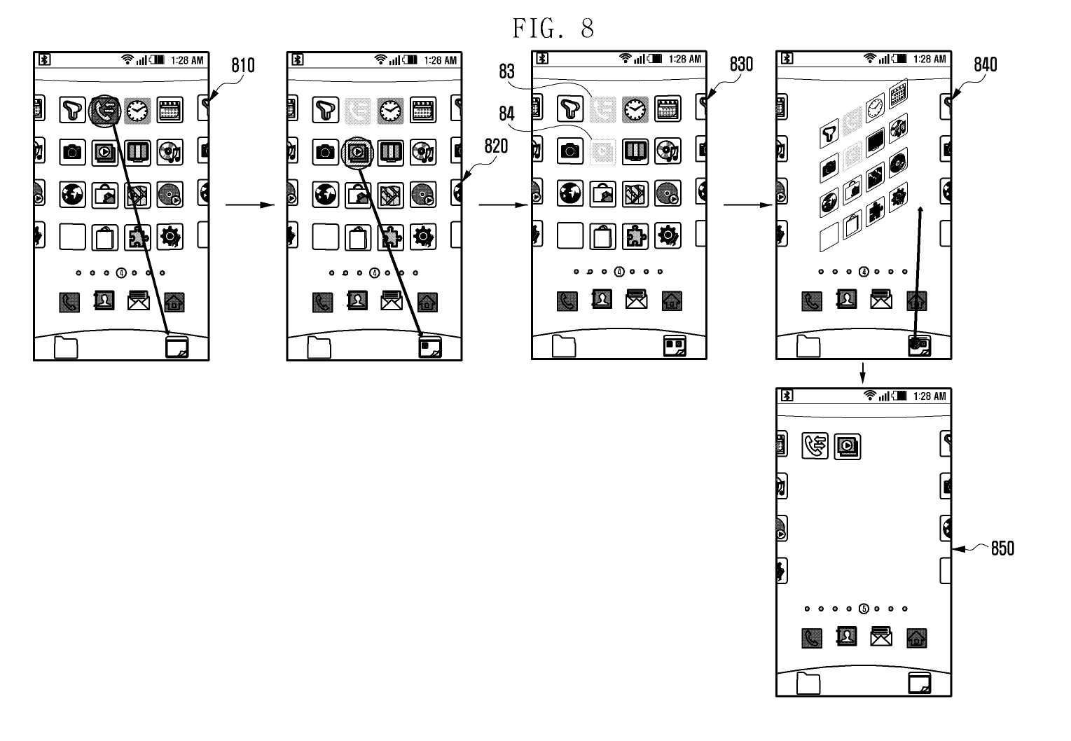

FIG. 8 is another illustration of item management using a 3D UI screen.

Referring now to FIG. 8, the control unit 110 may control the touchscreen 130 to output a 3D UI screen as indicated by screen reference numeral 810. The user may move an item in the item display region 20 to the make-page item 72 as indicated by screen reference numeral 810 or 820. Then, the control unit 110 may control the touchscreen 130 to display a distinctive ghost image 83, 84 at the previous position of the item having moved to the make-page item 72 as indicated by screen reference numeral 810.

The user may touch the make-page item 72, move the make-page item 72 to a desired position of the item display region 20, and release the make-page item 72 as indicated by screen reference numeral 840. Here, the touch release position may be in between pages. Then, the control unit 110 may produce a visual effect (for example, tilting the current page) to notify the user of page insertion as indicated by screen reference numeral 840.

After touch release, the control unit 110 may add a page at the touch release position and move the items in the make-page item 72 to the added page as indicated by screen reference numeral 850.

As described above, the “make page” function may be more easily performed using the make-page item 72. Although not shown in FIG. 8, to move one item individually, the user may enter a tap on the make-page item 72 that is detected by the touchscreen, and the control unit 110 may expand the make-page item 72 into a popup window. Thereafter, the user may select a desired item in the popup window and move the selected item to the item display region 20.

In another exemplary embodiment, the space between the make-folder item 71 and the make-page item 72 may be utilized as a region for stacking items as described in connection with FIGS. 3A to 6C.

The user interface providing method of the present invention according to the presently claimed invention is a statutory invention in compliance with 35 U.S.C. §101, and may be implemented as one or more computer programs comprising machine executable code that is loaded into hardware such as a processor and/or microprocessor and executed, such machine executable code may be stored in various computer readable storage media. The computer readable storage media may store program instructions, data files, data structures and combinations thereof. The program instructions are machine readable code that is loaded into hardware such as a processor, microprocessor, or control unit, and executed may include instructions developed specifically for the present invention and existing general-purpose instructions known to persons skilled in the art. The computer readable storage media comprises machine readable mediums specially designed a processor microprocessor to store and execute program instructions, and may include magnetic media such as a hard disk, floppy disk and magnetic tape, optical media such as a CD-ROM and DVD, magneto-optical media such as a floptical disk, and memory devices such as a ROM, RAM and flash memory. The program instructions that are loaded into hardware such as a process, microprocessor, or controller, may include machine codes produced by compilers and high-level language codes executable through interpreters. Each hardware device may be replaced with one or more software modules to perform operations according to the present invention, and vice versa.

According to an exemplary aspect of the present invention, the interface providing method and apparatus enable a mobile terminal to present a UI screen in a 3D format. Hence, the contents under of the UI screen may be readily understood s contents of the UI screen. Extra space obtained by 3D visualization in the UI screen can be used as an area for item management and execution of functions related to items. In other words, the extra space may be used to execute functions, which would be executed through complicated steps in a regular 2D UI screen, in a simple way, thereby enhancing user convenience.

For example, one or more items may be kept in the extra space and may be invoked as necessary. In addition, multiple items present in the extra space may be simultaneously deleted or simultaneously moved to their original positions in the 3D UI screen.

The above-described methods according to the present invention can be implemented in hardware, firmware or as software or computer code loaded into hardware such as a processor or microprocessor and executed, the machine executable code being stored on a recording medium such as a CD ROM, an RAM, a floppy disk, a hard disk, or a magneto-optical disk or computer code downloaded over a network originally stored on a remote recording medium or a non-transitory machine readable medium and to be stored on a local recording non-transitory medium, so that the methods described herein can be rendered in such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, thumbnail, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. A controller or control unit configured to perform a function as used herein includes hardware and is not to be construed as software per se.

Although the user interface providing method and apparatus for a mobile terminal have been described in detail hereinabove as exemplary embodiments of the present invention, it should be understood that many variations and modifications of the basic inventive concept described herein will still fall within the spirit and scope of the present invention as defined in the appended claims.

What is claimed is:

1. A user interface providing method for a mobile terminal, comprising:
outputting by a display a three-dimensional user interface screen (3D UI screen) having a first region comprising an item display region for item display and a second region comprising a drop table region for item management; and
managing by a controller at least one item being displayed using the second region.

2. The user interface providing method of claim 1, wherein outputting display of the 3D UI screen is performed by the display under control of the controller when an edit function is initiated on a two-dimensional (2D) menu or a 2D home screen containing a plurality of items.

3. The user interface providing method of claim 1, wherein the 3D UI screen is displayed in a shape of a cylinder or a shape of a prism.

4. The user interface providing method of claim 3, wherein the first region corresponds to a display of a face of the cylinder or a side of the prism, and the second region corresponds to a display of a base of the respective cylinder or prism.

5. The user interface providing method of claim 1, wherein managing by the controller at least one item comprises:
moving a display of items in the item display region to the drop table region; and
stacking by the controller the moved items into a pile for display in the drop table region.

6. The user interface providing method of claim 5, wherein moving items from the item display region to the drop table region includes displaying ghost images corresponding to the moved items at previously displayed positions of the moved items, wherein each ghost image is distinguished from the respective corresponding item that has been moved in terms of at least one of size, color and transparency so that said each ghost image is readily distinguishable from neighboring items in the item display region.

7. The user interface providing method of claim 5, wherein managing at least one item further comprises changing a display of the items stacked in a pile to a display in a spread form, in response to a touch input on the second region.

8. The user interface providing method of claim 5, wherein managing at least one item by the controller further comprises controlling movement of the display of the items stacked in the drop table region to the item display region.

9. The user interface providing method of claim 8, wherein moving the display of items stacked in the drop table region to the item display region comprises one of:
moving a display of a topmost one of the items stacked in the drop table region to the item display region by detecting a contact on a touchscreen at a position corresponding to the stacked items, in which the topmost item is moved to a desired position of the item display region by detecting a release of contact on the touchscreen corresponding to said topmost one of the items; and
displaying the items stacked in the drop table region in a spread form when the touchscreen detects tapping of the drop table region, a selecting one of the items in a spread form, and moving of the selected item to the item display region.

10. The user interface providing method of claim 8, wherein moving a display of the items stacked on the drop table region to the item display region comprises moving a display of all the items stacked on the drop table region to the item display region in response to an “empty” command.

11. The user interface providing method of claim 10, wherein moving all the items stacked on the drop table region comprises:
moving a display of items from the drop table region whose previous positions in the item display region are known back to their previous positions in the item display region;
moving the display of items in the drop table region whose previous positions in the item display region are unknown to empty positions in the item display region; and
adding, when there are no empty positions in the first region, a page, and moving the display of items in the drop table region to the added page.

12. The user interface providing method of claim 1, wherein managing at least one item by the controller comprises removing, in response to a “delete” command, applications associated with at least one item in the drop table region.

13. The user interface providing method of claim 1, wherein managing at least one item comprises creating, in response to a “make folder” command, a folder in the first region, and moving a display of all the items in the second region to the created folder in the first region.

14. The user interface providing method of claim 1, wherein managing at least one item comprises adding, in response to a “make page” command, a page at the first region, and moving a display of all the items in the second region to the added page.

15. The user interface providing method of claim 1, wherein the second region contains a make-folder item associated with a “make folder” function and a make-page item associated with a “make page” function.

16. A user interface providing apparatus for a mobile terminal, comprising:
a touchscreen configured for outputting a three-dimensional user interface screen (3D UI screen) having a first region comprising an item display region for item display and a second region comprising a drop table region for item management; and
a control unit configured for controlling management of at least one item via the drop table region.

17. The user interface providing apparatus of claim 16, wherein a display of the 3D UI screen is shaped as a cylinder or a prism.

18. The user interface providing apparatus of claim 17, wherein the first region corresponds to a face of the cylinder or a side of the prism, and the second region corresponds to a respective base of the cylinder or the prism.

19. The user interface providing apparatus of claim 16, wherein the second region contains a make-folder item associated with a “make folder” function configured in the control unit and a make-page item associated with a “make page” function.

20. The user interface providing apparatus of claim 16, wherein the 3D UI screen is output for display by the control unit when an edit function is initiated in a two-dimensional (2D) menu or 2D home screen containing a plurality of items.

21. The user interface providing apparatus of claim 16, wherein the control unit controls, when an item displayed in the first region is moved to the second region, the touchscreen to display a ghost image corresponding to the moved item at a previous position of the moved item, wherein the ghost image is distinguished from the corresponding moved item in terms of at least one of size, color and transparency in which the ghost image is readily distinguishable from neighboring items being displayed.

22. The user interface providing apparatus of claim 16, wherein the control unit controls movement of, in response to a touch gesture detected by the second region of the touchscreen, moving to a desired position of the first region and releasing, a topmost one of items stacked in a pile on the second region to a touch release position of the first region for display.

23. The user interface providing apparatus of claim 16, wherein the control unit changes the display of, in response to a detected tap on the second region, items stacked in a pile on the second region to be displayed in a spread form, and moves, in response to a detected touch on one of the items in a spread form, the touched item to the first region.

24. The user interface providing apparatus of claim 23, wherein the control unit is configured for moving a display of items in the second region whose previous positions in the first region are known, back to their previous positions, and moves a display of items in the second region whose previous positions in the first region are unknown to empty positions in the first region for display.

25. The user interface providing apparatus of claim 24, wherein the control unit is configured to add, when there is no empty position in the first region, a page and moves a display of items in the second region to the added page.

26. The user interface providing apparatus of claim 16, wherein the control unit removes a display of, in response to a “delete” command, applications associated with at least one item in the second region.

27. The user interface providing apparatus of claim 16, wherein the control unit is configured to create, in response to a “make folder” command, a folder at the first region, and moves a display of all items in the second region to the created folder.

28. The user interface providing apparatus of claim 16, wherein the control unit is configured to add, in response to a “make page” command, a page at the first region, and moves display of all items in the second region to the added page.
